(19) United States
(12) Patent Application Publication
(10) Pub. No.: US 2017/0057207 A1
(43) Pub. Date: Mar. 2, 2017

(54) COMPOSITE VENEER INCLUDING A NONWOVEN INNER PLY

(71) Applicant: Jason Douglas Crapo, Mauckport, IN (US)

(72) Inventor: Jason Douglas Crapo, Mauckport, IN (US)

(73) Assignee: Hi Tech Veneer LLC, Jeffersonville, IN (US)

(21) Appl. No.: 15/120,117

(22) PCT Filed: Apr. 3, 2014
(86) PCT No.: PCT/US14/32841

§ 371 Date: Aug. 18, 2016

Related U.S. Application Data
(60) Provisional application No. 61/942,476, filed on Feb. 20, 2014.

(51) Int. Cl. B32B 21/14; B32B 37/10; B32B 37/12; B32B 7/12; B32B 5/02

(52) U.S. Cl. CPC B32B 21/14; B32B 7/12; B32B 5/022; B32B 37/12; B32B 37/10; B32B 2262/0253; B32B 2262/0261; B32B 2262/0276; B32B 2262/062; B32B 2307/3065; B32B 2307/54; B32B 2307/702; B32B 2605/18

(57) ABSTRACT

A composite veneer including a cellulose outer face and a nonwoven inner ply for mounting to a curved support surface.

### CROSS-REFERENCE TO RELATED APPLICATIONS

This application claims priority to U.S. Provisional Application No. 61/942,476, filed Feb. 20, 2014, the entire disclosure of which is hereby incorporated by reference in its entirety.

### BACKGROUND AND SUMMARY OF THE INVENTION

The present invention relates generally to sheet veneer and, more particularly, to a composite veneer including a nonwoven inner ply and method of making same.

Decorative laminates, such as wood veneers, are popular wall coverings in a variety of settings. One application of such wood veneers is within aircraft passenger cabins. Traditional wood veneers often include a poplar wood inner ply positioned between wood outer faces or layers. Exemplary wood outer faces or layers include, but are not limited to, ash, bamboo, birch, cherry, hickory, mahogany, maple, oak, elm, poplar, teak, and walnut.

Wood veneers have become increasingly thinner, resulting in certain manufacturing difficulties, often along with quality and durability issues in the final product. For example, traditional veneers including a poplar wood inner ply often experience telegraphing, where the wood pattern from the inner ply shows through (e.g., as bumps and lines) in the finished surface of the outer face or layer. Such telegraphing may result from different shrinkage amounts of the veneer layers, often due to different relative moisture contents. It is therefore desired to provide a composite veneer that reduces telegraphing.

Traditional veneers including a poplar wood inner ply may also be susceptible to moisture absorption. Degradation results from moisture buildup, leading to the decomposition of traditional wood inner ply. The result is the buildup of CO₂ gas, which may attack the finish surface layer resulting in checking, hazing and delamination. It is desirable to provide a composite veneer that improves breathability characteristics and prevents moisture buildup.

It is also desired to provide a wood veneer including an inner ply that provides a flexural modulus lower than a traditional wood inner ply, thereby allowing the wood veneer to cover tight radiuses and curves. It is also desired to provide such a wood veneer with notably improved burn resistance (e.g., with a zero second extinguish rate after burn).

Again, there is a need for a composite wood veneer that prevents telegraphing for improved sanding efficiency and appearance, improves flexibility, burn resistance and stability, offers ease of manufacturing, especially during high torque handling, and extends product life and reduces material costs.

According to an illustrative embodiment of the present disclosure, a composite veneer includes a first outer wood face, a second outer wood face in parallel spaced relation to the first outer wood face, and a nonwoven inner ply positioned between the first outer wood face and the second outer wood face.

In one illustrative embodiment of the present disclosure, a composite veneer is provided. The composite veneer includes a first cellulose face, a second cellulose face in parallel spaced relation to the first cellulose face; and a nonwoven inner ply positioned intermediate the first cellulose face and the second cellulose face, the nonwoven inner ply formed from a plurality of polymer fibers. In one more particular embodiment of the composite veneer, the first cellulose face and the second cellulose face are formed of poplar wood. In another more particular embodiment of the composite veneer, the polymer fibers are formed of an at least partially amorphous polymer.

In a more particular embodiment of any of the composite veneers described above, the polymer fibers are formed of a novoloid. In one particular embodiment, the novoloid fiber contains at least 85% of a cross-linked novolak.

In a more particular embodiment of any of the composite veneers described above, the polymer is selected from the group consisting of: polystyrene, polymethylmethacrylate, polyphene sulfides, polysulfone, polyetherimide, polyetheretherketone, polyether sulfone, polyisobutylene, poly(vinyl acetate), and novoloid. In another more particular embodiment, the polymer fibers are formed of a polymer selected from the group consisting of: nylon, novoloid, novolac, phenolic fibers, melamines, polyesters, polypropylenes, polyethylenes, polystyrenes, polyacrylic acids, polyacrylonitrils, polyimides, polyetherimides, polyamideimides, polymethyl methacrylates, polyphenelene sulfides, aramids, polybenzimidazoles, polyphenylenebenzobizoxazoles, aromatic polyketones, polyvinyl acetates, polysulfones, polyethersulfones, polyurethanes, polyisobutylenes, liquid crystal polymers, and poly(paraphenylene terephthalamide).

In a more particular embodiment of any of the composite veneers described above, the inner ply further comprises a synthetic latex. In a more particular embodiment of any of the composite veneers described above, the inner ply further includes a flame retardant. In one embodiment, the composite veneer has a zero second extinguish rate after burn.

In a more particular embodiment of any of the composite veneers described above, the nonwoven inner ply is a needle punched nonwoven material.

In one embodiment, the composite veneer has a flexural modulus according to ASTM D790 of about 2 times lower, about 4 times lower, about 4.5 times lower, about 5 times lower, or lower, or within any range defined between any two of the foregoing values than that of a similarly constructed standard three-ply veneer having a cellulose inner ply, such as poplar. In one embodiment, the composite veneer has a bending radius as low as about 0.20 inches parallel to wood grain. In one embodiment, the composite veneer has a bending radius as low as about 1.25 inches perpendicular to wood grain.

In a more particular embodiment of any of the composite veneers described above, the composite veneer further includes a first adhesive layer between the first cellulose face and the nonwoven inner ply, and a second adhesive layer between the nonwoven inner ply and the second cellulose face. In one embodiment, the first and second adhesive layers independently comprise an adhesive selected from the group consisting of: a phenolic glue and an acrylic melamine glue.

In another illustrative embodiment of the present disclosure, a method of forming a composite veneer is provided. The method includes providing a first cellulose face; providing a nonwoven ply formed from a plurality of polymer fibers; adhering the nonwoven ply to the first cellulose face with a first glue line; pressing the first cellulose face, first glue line, and nonwoven ply in a press at elevated temperature and pressure to form a two ply composite; adhering a second cellulose face to the nonwoven ply of the two ply composite with a second glue line; and pressing the two ply composite, second glue line, and second cellulose in a press at elevated temperature and pressure to form the composite veneer.

In one embodiment, the method further comprises slicing a log to form a plurality of sheets; splicing a first portion of the plurality of sheets with an adhesive to form the first cellulose face; and splicing a second portion of the plurality of sheets with an adhesive to form the second cellulose face.

In a more particular embodiment of any of the above methods, the elevated temperature is about 350° F. In a more particular embodiment of any of the above methods the elevated pressure is about 230 bar.

In a more particular embodiment of any of the above methods, the method further includes pressing the nonwoven ply at an elevated temperature and pressure.

In a more particular embodiment of any of the above methods, the method further includes cooling the two-ply composite to room temperature.

In a more particular embodiment of any of the above methods, the method further includes treating the composite veneer with a fire retardant.

In a more particular embodiment of any of the above methods, the polymer fibers are formed of a novoloid.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative composite veneer of the present disclosure;

FIG. 2 is a cross-sectional view of the composite wood veneer of FIG. 1; and

FIG. 3 is a flowchart illustrating a method of manufacturing the composite wood veneer of FIG. 1.

### DETAILED DESCRIPTION OF THE DRAWINGS

The embodiments of the invention described herein are not intended to be exhaustive or to limit the invention to precise forms disclosed. Rather, the embodiments elected for description have been chosen to enable one skilled in the art to practice the invention.

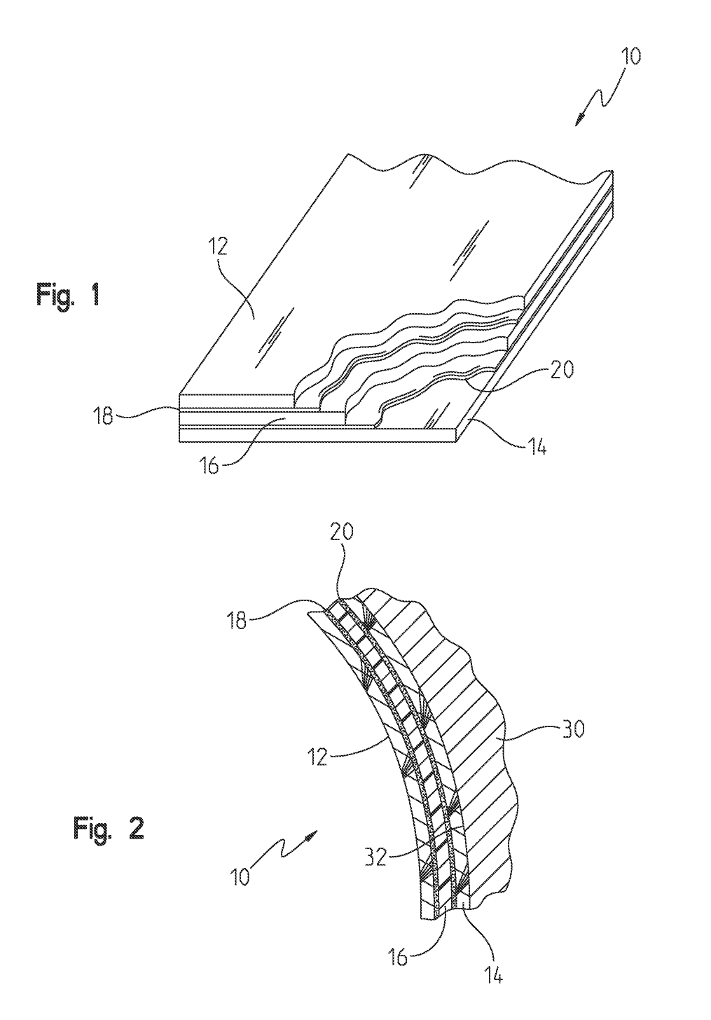

Referring initially to FIGS. 1 and 2, an illustrative composite wood veneer 10 of the present disclosure is shown for mounting to a support structure, such as a wall 30 of an aircraft including a curved mounting surface 32. The composite veneer 10 includes multiple layers including a first outer face or layer 12, a second outer face or layer 14, and an inner ply or layer 16. A first adhesive layer 18 is positioned between the first outer face 12 and the inner ply 16, and a second adhesive layer 20 is positioned between the second outer face 14 and the inner ply 16.

In the illustrative embodiment, the first and second outer faces 12 and 14 each comprise a cellulose material, such as, but not limited to, ash, bamboo, birch, cherry, hickory, mahogany, maple, oak, elm, poplar, teak, and walnut. More particularly, each of the outer faces 12 and 14 illustratively comprises a wood sheet, such as poplar or cherry having a thickness of approximately 0.024 inches. The inner ply 16 is illustratively formed of a three-dimensional needlepunch nonwoven material. The nonwoven material illustratively combines high tensile synthetic fibers with chemical enhancement to provide advantageous thermodynamic properties in a semi-flexible, stiff isolating core. The needle punching provides tensile strength and controlled elongation.

The fibrous material of the nonwoven inner ply 16 illustratively comprises polymer fibers of suitable strength arranged in a substantially parallel unwoven relation in a tenuous web form. Various amorphous, partially amorphous and non-amorphous polymer fibers may be used alone or in combination within the nonwoven inner ply 16.

The first illustrative type of polymer fibers of the nonwoven inner ply 16 are completely amorphous, or at least have regions that are amorphous. Non-limiting examples of polymers that are amorphous, at least in some cases, include polystyrene, polymethylmethacrylate, polyphenelene sulfides, polysulfone, polyetherimide (e.g., Ultem® from SABIC), polyetheretherketone, polyethersulfone, polyisobutylene, poly(vinyl acetate), novoloid (e.g., Kynol® from American Kynol), and the like.

The second illustrative type of polymer fibers of the nonwoven inner ply 16 are illustratively completely non-amorphous or only partially amorphous. Examples of such polymers include polyamides such as nylons, novoloid (e.g., Kynol® from American Kynol), novolacs, phenolic fibers, melamines, polyesters, polypropylenes, polyethylenes, polystyrenes, polyacrylic acids, polyacrylonitriles, polyimides, polyetherimides, polyamideimides, polymethyl methacrylates, polyphenelene sulfides, aramids (e.g., meta- or para-aramids, e.g., Kevlar® from Dupont), polybenzimidazoles, polyphenylenebenzobizoxazoles, aromatic polyketones (e.g., polyetheretherketones, polyetherketoneketones, etc.), polyvinyl acetates, polysulfones, polyethersulfones, polyurethanes, polyisobutylenes, liquid crystal polymers, and poly(paraphenylene terephthalamide).

In certain illustrative embodiments, novoloid fibers are used for the nonwoven inner ply 16. Novoloid fibers are cured phenol-aldehyde fibers made by acid-catalysed cross-linking of metal-spun novolak resin to form a fully cross-lined, three-dimensional, amorphous network polymer structure similar to that of thermo-setting phenolic resins. Novoloid is recognized in the industry as a manufactured fiber containing at least 85% of a cross-linked novolak, and is available as Kynol® from American Kynol of Pleasantville, N.Y.

A variety of technologies may be used to stabilize fibers into a nonwoven matrix of fibers, including mechanically, chemically, and/or thermal bonding. More particularly, various non-woven materials may be formed by needlepunch (i.e., mechanical interlocking of fibers), chemical bonding, thermal bonding, hydro-entanglement, spun bonding, melt blown, and wet laid. These various processes may be combined to improve the chemical resistance, mechanical attributes, and required modulus, flexibility, and tensile strength for veneer core or inner ply 16.

The chemical enhancement of the inner ply 16 is illustratively a synthetic latex formulated to further enhance the needle punched nonwoven material and provide additional flame retardant properties. The thermodynamic properties of a combination of flame retardant chemicals in the treatment provides for flame suppression to assist in the control of thermal degradation of the cellulose veneer.

Examples of flame retardants include, but are not limited to, minerals such as aluminum hydroxide, aluminum oxide, aluminum trihydrate, magnesium carbonate hydroxide, magnesium hydroxide, huntite, hydromagnesite, hydrates, red phosphorus, boron compounds such as zinc borate or sodium borate, zinc carbonate, antimony trioxide, antimony pentoxide, sodium antimonate, sodium carbonate, antimony carbonate, aluminum carbonate, etc.; organochlorines such as chlorendic acid derivatives and chlorinated paraffins; organobromines such as polybrominated diphenylethers, decabromodiphenyl ether, decabromodiphenyl ethane, hexabromobutene, dibromoethyl dibromocyclohexane, hexabromocyclododecane, diboromoneopentyl glycol, tribromoneopentyl alcohol, brominated aliphatic polyol, polyethertriol, octabromodiphenyl ether, pentabromodiphenyl ether, fully brominated diphenoxy benzene, decabromodiphenyl ether, octabromodiphenylether, pentabromodiphenylether, (bis-pentabromophenyl)ethane, brominated trimethylphenylindan, tetrabromobisphenol A, bis(tribromophenoxy)ethane, polydibromophenylene oxide, tetrabromophthalic anhydride, 1,2-bis(tetrabromophthalimide)ethane, tetrabromophthalate diols, tetrabromophthalate esters, tetrabromobisphenol A, polydibromophenylene oxide, brominated polystyrene, poly(pentabromobenzyl)acrylate, polymeric brominated compounds such as brominated polystyrenes, brominated carbonate oligomers, brominated epoxy oligomers, tetrabromophthalic anyhydride, tetrabromobisphenol A, hexabromocyclododecane, etc.; sulfamic acid or sulfamates; sulfamides; or organophosphorous or organophosphate compounds such as tris(2,3-dibromopropyl) phosphate,triphenyl phosphate, tris-dichloropropyl phosphate, cresyldiphenyl phosphate, resorcinol bis(diphenylphosphate), bisphenol A bis(diphenyl phosphate), melamine phosphate, tri-o-cresyl phosphate, dimethyl methylphosphonate, phosphinates, tri-m-cresyl phosphate, tris(2-chloropropyl) phosphate, tris-(1.3-dichloro-2-propyl) phosphate, tris(chloroethyl) phosphate, trisdichloropropylphosphate, tri-p-cresyl phosphate, trischloropropylphosphate, tris(chloroisopropyl)phosphate, tri(isopropylphenyl)phosphate, tetrakis(2-chloroethyl) dichloroisopentyldiphosphate, dimethyl methyl phosphonate, 9,10-dihydro-9-oxa-10-phosphaphenanthrene-10-oxide, 6-(2,5-dihydroxyphenyl)-6H-dibenz[c,e][1,2]oxaphosphorine-6-oxide, tetraphenyl resorcinol bis(diphenylphosphate), etc. In addition, combinations of any of these and/or other flame retardants may be used.

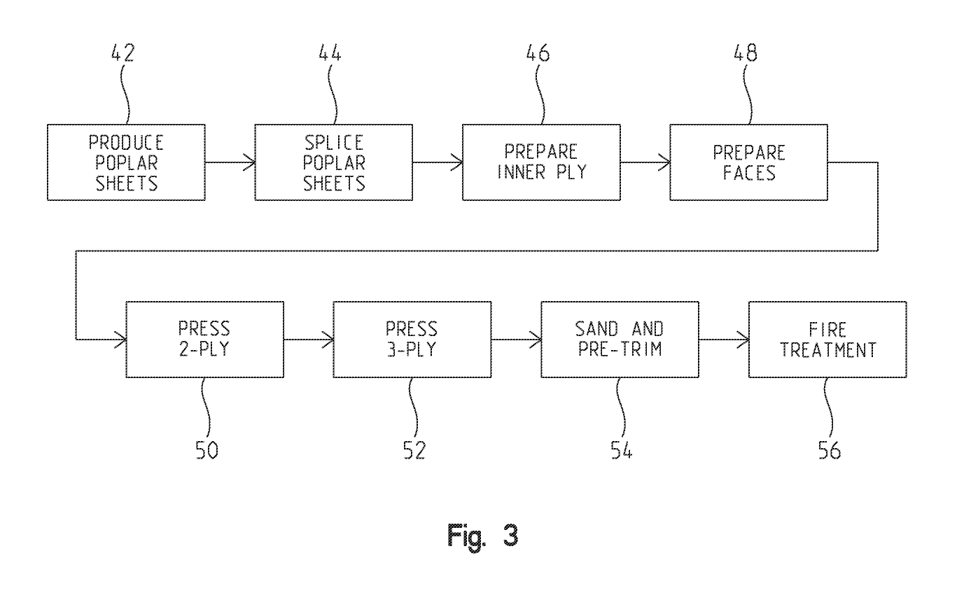

With reference to FIG. 3, an illustrative method of manufacturing composite veneer 10 of the present disclosure begins with producing wood, illustratively poplar sheets at step 42. More particularly, a poplar log is sliced to form 0.024 inch thick leaves or sheets. Half round slicing is illustratively utilized to ensure consistency. Half round slicing is defined as cutting on an arc roughly parallel to the center of a log to achieve flat-cut leaves or sheets. Next, the poplar sheets are stacked and press dried until there is between 7% to 10% moisture content. The poplar sheets are then prepared for splicing. For example, opposing edges of each sheet are cut in parallel.

The illustrative method continues to step 44 where the poplar sheets are spliced together to define the outer faces 12 and 14. Edges of the previously formed poplar sheets are spliced together, illustratively through an adhesive such as urea glue. The formed outer faces 12 and 14 are then visually inspected on a light table for imperfections, such as varying thicknesses (i.e., too thick or thin), open joints, chips, and/or cracks. Faces 12 and 14 displaying such imperfections are rejected to avoid telegraphing. Next, the faces 12 and 14 are sanded, illustratively through aluminum oxide discs, to smooth glue joints. The faces 12 and 14 are then inspected on a light table for uneven sanding.

The illustrative method then continues at step 46 where the nonwoven inner ply 16 is prepared to press. Additional details on illustrative compositions and methods of forming nonwoven inner ply 16 are provided above. Initially, the inner ply 16 is visually inspected for folds and overlaps. A light table is then used to visually inspect the inner ply 16 for varying thicknesses (i.e., too thick or thin), light spots, uneven patterns, and/or debris. The inner ply 16 is then pressed for compression and uniformity. More particularly, the inner ply 16 is placed within a press having platens heated to a temperature of 165° F. The inner ply 16 is then pressed between the platens at 100 bars of pressure for 10 seconds. The pressure is released and then the platens again press the inner ply 16 at 100 bars of pressure for 15 seconds. The inner ply 16 is then inspected for uneven pressure by measuring the thicknesses on opposing sides. Any inner ply 16 having more than 0.002 to 0.003 inches variation in thickness is rejected.

The illustrative method continues to step 48 where the outer faces 12 and 14 are prepared for pressing onto the inner ply 16. More particularly, the faces 12 and 14 are inspected for quality and compliance with customer specifications. The faces 12 and 14 are then sorted and stacked prior to cutting and drying. Each face 12 and 14 is then inspected on a light table before splicing or hand taping. Faces 12 and 14 are spliced together per customer specifications (e.g., outer dimensions). A further inspection is performed on a light table. Faces 12 and 14 are then stacked in a temperature controlled room at 80° F. for 24 hours. Next, the faces 12 and 14 are pressed to dry. More particularly, each face 12 and 14 is placed in a press between platens heated to 180° F. Each face 12 and 14 is pressed for 10 seconds with only the weight of the platen applying pressure (i.e., no hydraulic pressure). The pressing is repeated until no steam is present from the face 12, 14 between the platens. At that point, the face 12, 14 is removed from the press and stored at room temperature.

At method step 50, the outer face 12 is pressed to the inner ply 16 to define a 2-ply veneer. Plies 12 and 16 are initially inspected for debris. Next, the inner ply 16 is placed above glue line 18 which, in turn, is placed above the outer face 12. Illustratively, the glue line 18 may be defined by a variety of adhesives based upon the specifications of the outer face 12. Illustrative adhesives for glue line 18 include glues include Tego phenolic glue, 204TS phenolic glue, and 330TS acrylic melamine glue. The assembled layers 12, 16 and glue line 18 are then placed in a press with platens heated to 350° F. The layers 12, 16 and glue line 18 are pressed for 6 minutes, 30 seconds at 230 bars of pressure. The formed 2-ply veneer is then removed from the press and allowed to cool to room temperature.

The illustrative method then continues at step 52, where the outer face 16 is pressed to the 2-ply previously formed from the outer face 12 and the inner ply 16. The outer face 14 is placed above the glue line 20. Glue line 20 may be similar to glue line 18 identified above. The outer face 14 is next pressed to the two ply (including outer face 12 and inner ply 16). The assembled layers 12, 14, 16 and glue lines 18, 20 are then placed in a press with platens heated to 350° F. The layers 12, 14, 16 and glue lines 18, 20 are pressed for 6 minutes, 30 seconds at 230 bars of pressure. The formed 3-ply veneer is then removed from the press and allowed to cool to room temperature.

Sanding and trimming of the formed 3-ply veneer 10 occurs at step 54. More particularly, edges are pre-trimmed to remove oversized face 12, 14 and inner ply 16 material. Any debris is removed and the veneer 10 is stored. The veneer 10 is then sanded to customer specifications.

The illustrative method continues to step 56, where the veneer 10 is fire treated. The veneer 10 is illustratively fire treated with a fire retardant chemical, such as TFP-III, available from Eagle Performance Products of Calhoun, Ga. Each veneer sheet 10 is dipped into the fire retardant for approximately 5 minutes. The veneer 10 is then removed and drip dried for 5 minutes. The veneer 10 is then placed in a well-ventilated room and fan dried to 10 to 14% moisture content. A 60 second burn test is then performed. If the veneer 10 fails the test, then the treatment process is repeated. The veneer 10 is then allowed to sit for 24 to 48 hours before shipping to customers.

The resulting veneer sheet 10 may be produced in various dimensions, such as 48 inches by 96 inches, and 48 inches by 120 inches. The illustrative thickness of veneer sheet 10 is 0.059 inches +/−0.005 inches. The veneer sheet 10 illustratively has a mean weight of 0.213 lb/ft², a tear resistance of 14.3+/−1.9 lbs., and a moisture regain of 7.3%+/−0.2% at 50% humidity. The sheet 10 illustratively has a bending radius as low as 0.20 inches parallel to wood grain, and as low as 1.25 inches perpendicular to wood grain. The sheet 10 meets flammability requirements per FAR 25-853(a), 14 CFR 25.853(a) App. F Part 1(a)(1)(i): 60 second vertical impingement.

The flexural modulus of an illustrative sample of a cherry veneer including a novoloid nonwoven inner ply was compared to that of a typical 3-ply cherry veneer with a poplar cellulose inner ply. The testing was conducted per ASTM D790-97 on a 6″ by 1″ sample in both the machine direction (MD) and cross-machine direction (XD). The results are presented in Table 1.

TABLE 1
Flexural Modulus Results

| | Modulus of Elasticity |
|---|---|
| | N/mm² |
| Non-woven inner ply MD | 3277.2 |
| Typical 3-ply MD | 16631.5 |
| Non-woven inner ply XD | 443.5 |
| Typical 3-ply XD | 1947.8 |

As shown in Table 1, the non-woven inner ply containing sample illustratively has a flexural modulus about 5.1 times lower than the typical 3-ply sample in the machine direction and about 4.5 times lower in the cross-machine direction.

Although the invention has been described in detail with reference to certain preferred embodiments, variations and modifications exist within the spirit and scope of the invention as described and defined in the following claims.

1. A composite veneer including:
a first cellulose face;
a second cellulose face in parallel spaced relation to the first cellulose face; and
a nonwoven inner ply positioned intermediate the first cellulose face and the second cellulose face, the nonwoven inner ply formed from a plurality of polymer fibers.

2. The composite veneer of claim 1, wherein the polymer fibers are formed of an at least partially amorphous polymer.

3. The composite veneer of claim 1, wherein the polymer fibers are formed of a novoloid.

4. The composite veneer of claim 1, wherein the polymer is selected from the group consisting of: polystyrene, polymethylmethacrylate, polyphene sulfides, polysulfone, polyetherimide, polyetheretherketone, polyether sulfone, polyisobutylene, poly(vinyl acetate), and novoloid.

5. The composite veneer of claim 1, wherein the polymer fibers are formed of a polymer selected from the group consisting of: nylon, novoloid, novolac, phenolic fibers, melamines, polyesters, polypropylenes, polyethylenes, polystyrenes, polyacrylic acids, polyacrylonitrils, polyimides, polyetherimides, polyamideimides, polymethyl methacrylates, polyphenelene sulfides, aramids, polybenzimidazoles, polyphenylenebenzobizoxazoles, aromatic polyketones, polyvinyl acetates, polysulfones, polyethersulfones, polyurethanes, polyisobutylenes, liquid crystal polymers, and poly(paraphenylene terephthalamide).

6. The composite veneer of claim 1, wherein the inner ply further comprises a synthetic latex.

7. The composite veneer of claim 1, wherein the inner ply further includes a flame retardant.

8. The composite veneer of claim 1, wherein the composite veneer has a zero second extinguish rate after burn.

9. The composite veneer of claim 1, wherein the nonwoven inner ply is a needle punched nonwoven material.

10. The composite veneer of claim 1, wherein the first cellulose face and the second cellulose face are formed of poplar wood.

11. The composite veneer of claim 1, further including:
a first adhesive layer between the first cellulose face and the nonwoven inner ply; and
a second adhesive layer between the nonwoven inner ply and the second cellulose face.

12. The composite veneer of claim 11, wherein the first and second adhesive layers independently comprise an adhesive selected from the group consisting of: a phenolic glue and an acrylic melamine glue.

13. The composite veneer of claim 1, wherein the composite veneer has a flexural modulus at least about 4 times lower than similarly constructed three-ply veneer having a cellulose inner ply.

14. The composite veneer of claim 1, wherein the composite veneer has a bending radius of about 0.20 inches parallel to a wood grain of the first and second cellulose faces.

15. A method of forming a composite veneer, the method comprising:
providing a first cellulose face;
providing a nonwoven ply formed from a plurality of polymer fibers;
adhering the nonwoven ply to the first cellulose face with a first glue line;
pressing the first cellulose face, first glue line, and nonwoven ply in a press at elevated temperature and pressure to form a two ply composite;
adhering a second cellulose face to the nonwoven ply of the two ply composite with a second glue line; and
pressing the two ply composite, second glue line, and second cellulose in a press at elevated temperature and pressure to form the composite veneer.

16. The method of claim 15, further comprising:
slicing a log to form a plurality of sheets;
splicing a first portion of the plurality of sheets with an adhesive to form the first cellulose face; and
splicing a second portion of the plurality of sheets with an adhesive to form the second cellulose face.

17. The method of claim 15, further comprising pressing the nonwoven ply at an elevated temperature and pressure.

18. The method of claim 15, further comprising treating the composite veneer with a fire retardant.

19. The method of claim 15, wherein the polymer fibers are formed of a novoloid.

20. The method of claim 15, wherein the elevated temperature is about 350° F. and the elevated pressure is about 230 bar.
